(19) United States
(12) Patent Application Publication
(10) Pub. No.: US 2025/0390875 A1
(43) Pub. Date: Dec. 25, 2025

(54) Method, System, and Computer Program Product for Auto-Profiling Anomalies

(71) Applicant: Visa International Service Association, San Francisco, CA (US)

(72) Inventors: Linyun He, Cedar Park, TX (US); Chiranjeet Chetia, Round Rock, TX (US); Jianhua Huang, Cedar Park, TX (US); Shubham Agrawal, Round Rock, TX (US); Mert Kosan, Austin, TX (US)

(21) Appl. No.: 18/702,496

(22) PCT Filed: Sep. 21, 2022
(86) PCT No.: PCT/US2022/044227

§ 371 Date: Apr. 18, 2024

Related U.S. Application Data
(60) Provisional application No. 63/257,662, filed on Oct. 20, 2021.

(51) Int. Cl. G06Q 20/40

(52) U.S. Cl. CPC G06Q 20/4016

(57) ABSTRACT

Methods, systems, and computer program products for auto-profiling anomalies that: receive anomaly transactions, select a subset of anomaly transactions, the subset of anomaly transactions being associated with a plurality of features, generate, based on the plurality of features and a distribution of the plurality of features, a plurality of weights associated with the plurality of features; segment, using an unsupervised clustering algorithm, based on the plurality of features and the plurality of weights, the subset of anomaly transactions into a plurality of segments of anomaly transactions; and label a subset of segments of the plurality of segments with a feature profile including a feature from each segment of the subset of segments associated with a highest weight of the plurality of weights of the plurality of features of the anomaly transactions in that segment.

### CROSS-REFERENCE TO RELATED APPLICATIONS

This application is the United States national phase of International Application No. PCT/US2022/044227 filed Sep. 21, 2022, and claims priority to U.S. Provisional Patent Application No. 63/257,662, filed on Oct. 20, 2021, the disclosures of which are incorporated by reference herein in their entireties.

### BACKGROUND

### 1. Technical Field

This disclosure relates to anomaly detection and, in some non-limiting embodiments or aspects, to methods, systems, and computer program products for auto-profiling anomalies.

### 2. Technical Considerations

Although there are systems for automatically flagging anomalies in transaction processing networks, manual efforts are used to profile the flagged anomalies and recommend corresponding strategies therefor, such as for cash-outs, account-take overs, uninformed configuration changing, and/or the like. Accordingly, there is a need for a mechanism that can efficiently automatically profile anomalies received in streaming data (e.g., determine whether a transaction identified as an anomaly is actually a fraudulent transaction and/or a category or type of the anomaly, etc.).

### SUMMARY

Accordingly, provided are improved systems, devices, products, apparatus, and/or methods for auto-profiling anomalies.

According to some non-limiting embodiments or aspects, provided is a computer-implemented method, including: receiving, with at least one processor, a plurality of anomaly transactions identified as anomalies by an anomaly detection system within a plurality of transactions; selecting, with the at least one processor, a subset of anomaly transactions of the plurality of anomaly transactions, wherein the subset of anomaly transactions is associated with a plurality of features; generating, with the at least one processor, based on the plurality of features associated with the subset of anomaly transactions and a distribution of the plurality of features associated with the subset of anomaly transactions, a plurality of weights associated with the plurality of features associated with the subset of anomaly transactions; segmenting, with the at least one processor, using an unsupervised clustering algorithm, based on the plurality of features associated with the subset of anomaly transactions and the plurality of weights associated with the plurality of features associated with the subset of anomaly transactions, the subset of anomaly transactions into a plurality of segments of anomaly transactions; and labeling, with the at least one processor, a subset of segments of the plurality of segments with a feature profile including a feature from each segment of the subset of segments associated with a highest weight of the plurality of weights of the plurality of features of the anomaly transactions in that segment.

In some non-limiting embodiments or aspects, selecting the subset of anomaly transactions of the plurality of anomaly transactions includes determining a sample size n of the subset of anomaly transactions based on a distance d of true values of a multinomial population of the plurality of anomaly transactions at a significance level a.

In some non-limiting embodiments or aspects, the plurality of weights associated with the plurality of features associated with the subset of anomaly transactions is generated according to the following Equations:

$${q}_{N} ( x ) = {\sum }_{i = 1}^{N} p ( {x}_{i} ) N \leq K$$

$$s ( x ) = \frac{{\sum }_{N = 1}^{K} {q}_{N} ( x ) {e}^{- ( N - 1 )}}{{\sum }_{N = 1}^{K} {e}^{- ( N - 1 )}}$$

where xᵢ is a feature of the plurality of features, where xᵢ: p(xᵢ) i=1, 2, . . . , K, where i is a feature category, where K is a number of feature categories, where p(xᵢ) is a distribution of the features, where p(x₁)>p(x₂)> . . . >p(x_{K}), where q_{N}(x) is a cumulative sum of the probability distribution, where N is a selected number of feature categories, and where s(x) is a weight of the plurality of weights associated with the feature xᵢ.

In some non-limiting embodiments or aspects, the unsupervised clustering algorithm includes a modular-transform based clustering algorithm.

In some non-limiting embodiments or aspects, the method further includes: generating, with the at least one processor, using the anomaly detection system, during processing of the plurality of transactions in a transaction processing network, the plurality of anomaly transactions identified as anomalies within the plurality of transactions.

In some non-limiting embodiments or aspects, the anomaly detection system includes a fraud detection model, and wherein the plurality of anomaly transactions is identified as fraudulent transactions.

In some non-limiting embodiments or aspects, the method further includes: receiving, with the at least one processor, a current transaction currently being processed in the transaction processing network; generating, with the at least one processor, using the anomaly detection system, a current anomaly transaction identified as a current anomaly; automatically labeling, with the at least one processor, the current anomaly transaction by comparing one or more features associated with the current anomaly transaction to the feature profile, wherein the current anomaly transaction is labeled with the feature profile in response to a threshold number of the one or more features associated with the current anomaly transaction matching a threshold number of features in the feature profile; and updating, with the at least one processor, based on the current anomaly transaction, the feature profile.

According to some non-limiting embodiments or aspects, provided is a system including: at least one processor configured to: receive a plurality of anomaly transactions identified as anomalies by an anomaly detection system within a plurality of transactions; select a subset of anomaly transactions of the plurality of anomaly transactions, wherein the subset of anomaly transactions is associated with a plurality of features; generate, based on the plurality of features associated with the subset of anomaly transactions and a distribution of the plurality of features associated with the subset of anomaly transactions, a plurality of weights associated with the plurality of features associated with the subset of anomaly transactions; segment, using an unsupervised clustering algorithm, based on the plurality of features associated with the subset of anomaly transactions and the plurality of weights associated with the plurality of features associated with the subset of anomaly transactions, the subset of anomaly transactions into a plurality of segments of anomaly transactions; and label a subset of segments of the plurality of segments with a feature profile including a feature from each segment of the subset of segments associated with a highest weight of the plurality of weights of the plurality of features of the anomaly transactions in that segment.

In some non-limiting embodiments or aspects, the at least one processor is configured to select the subset of anomaly transactions of the plurality of anomaly transactions by determining a sample size n of the subset of anomaly transactions based on a distance d of true values of a multinomial population of the plurality of anomaly transactions at a significance level a.

In some non-limiting embodiments or aspects, the at least one processor is configured to generate the plurality of weights associated with the plurality of features associated with the subset of anomaly transactions according to the following Equations:

$${q}_{N} ( x ) = {\sum }_{i = 1}^{N} p ( {x}_{i} ) N \leq K$$

$$s ( x ) = \frac{{\sum }_{N = 1}^{K} {q}_{N} ( x ) {e}^{- ( N - 1 )}}{{\sum }_{N = 1}^{K} {e}^{- ( N - 1 )}}$$

where xᵢ is a feature of the plurality of features, where xᵢ: p(xᵢ) i=1, 2, . . . , K, where i is a feature category, where K is a number of feature categories, where p(xᵢ) is a distribution of the features, where p(x+)>p(x₂)> . . . >p(x_{K}), where q_{N}(x) is a cumulative sum of the probability distribution, where N is a selected number of feature categories, and where s(x) is a weight of the plurality of weights associated with the feature xᵢ.

In some non-limiting embodiments or aspects, the unsupervised clustering algorithm includes a modular-transform based clustering algorithm.

In some non-limiting embodiments or aspects, the at least one processor is further configured to: generate, using the anomaly detection system, during processing of the plurality of transactions in a transaction processing network, the plurality of anomaly transactions identified as anomalies within the plurality of transactions.

In some non-limiting embodiments or aspects, the anomaly detection system includes a fraud detection model, and wherein the plurality of anomaly transactions is identified as fraudulent transactions.

In some non-limiting embodiments or aspects, the at least one processor is further configured to: receive a current transaction currently being processed in the transaction processing network; generate, using the anomaly detection system, a current anomaly transaction identified as a current anomaly; automatically label the current anomaly transaction by comparing one or more features associated with the current anomaly transaction to the feature profile, wherein the current anomaly transaction is labeled with the feature profile in response to a threshold number of the one or more features associated with the current anomaly transaction matching a threshold number of features in the feature profile; and update based on the current anomaly transaction, the feature profile.

According to some non-limiting embodiments or aspects, provided is a computer program product including a non-transitory computer readable medium including program instructions which, when executed by at least one processor, cause the at least one processor to: receive a plurality of anomaly transactions identified as anomalies by an anomaly detection system within a plurality of transactions; select a subset of anomaly transactions of the plurality of anomaly transactions, wherein the subset of anomaly transactions is associated with a plurality of features; generate, based on the plurality of features associated with the subset of anomaly transactions and a distribution of the plurality of features associated with the subset of anomaly transactions, a plurality of weights associated with the plurality of features associated with the subset of anomaly transactions; segment, using an unsupervised clustering algorithm, based on the plurality of features associated with the subset of anomaly transactions and the plurality of weights associated with the plurality of features associated with the subset of anomaly transactions, the subset of anomaly transactions into a plurality of segments of anomaly transactions; and label a subset of segments of the plurality of segments with a feature profile including a feature from each segment of the subset of segments associated with a highest weight of the plurality of weights of the plurality of features of the anomaly transactions in that segment.

In some non-limiting embodiments or aspects, the program instructions, when executed by the at least one processor, further cause the at least one processor to select the subset of anomaly transactions of the plurality of anomaly transactions by determining a sample size n of the subset of anomaly transactions based on a distance d of true values of a multinomial population of the plurality of anomaly transactions at a significance level a.

In some non-limiting embodiments or aspects, the program instructions, when executed by the at least one processor, further cause the at least one processor to generate the plurality of weights associated with the plurality of features associated with the subset of anomaly transactions according to the following Equations:

$${q}_{N} ( x ) = {\sum }_{i = 1}^{N} p ( {x}_{i} ) N \leq K$$

$$s ( x ) = \frac{{\sum }_{N = 1}^{K} {q}_{N} ( x ) {e}^{- ( N - 1 )}}{{\sum }_{N = 1}^{K} {e}^{- ( N - 1 )}}$$

where xᵢ is a feature of the plurality of features, where xᵢ: p(xᵢ) i=1, 2, . . . , K, where i is a feature category, where K is a number of feature categories, where p(xᵢ) is a distribution of the features, where p(x₁)>p(x₂)> . . . >p(x_{K}), where q_{N}(x) is a cumulative sum of the probability distribution, where N is a selected number of feature categories, and where s(x) is a weight of the plurality of weights associated with the feature xᵢ.

In some non-limiting embodiments or aspects, the unsupervised clustering algorithm includes a modular-transform based clustering algorithm.

In some non-limiting embodiments or aspects, the program instructions, when executed by the at least one processor, further cause the at least one processor to: generate, using the anomaly detection system, during processing of the plurality of transactions in a transaction processing network, the plurality of anomaly transactions identified as anomalies within the plurality of transactions.

In some non-limiting embodiments or aspects, the program instructions, when executed by the at least one processor, further cause the at least one processor to: receive a current transaction currently being processed in the transaction processing network; generate, using the anomaly detection system, a current anomaly transaction identified as a current anomaly; automatically label the current anomaly transaction by comparing one or more features associated with the current anomaly transaction to the feature profile, wherein the current anomaly transaction is labeled with the feature profile in response to a threshold number of the one or more features associated with the current anomaly transaction matching a threshold number of features in the feature profile; and update based on the current anomaly transaction, the feature profile.

Further non-limiting embodiments or aspects are set forth in the following numbered clauses:

Clause 1. A computer-implemented method, comprising: receiving, with at least one processor, a plurality of anomaly transactions identified as anomalies by an anomaly detection system within a plurality of transactions; selecting, with the at least one processor, a subset of anomaly transactions of the plurality of anomaly transactions, wherein the subset of anomaly transactions is associated with a plurality of features; generating, with the at least one processor, based on the plurality of features associated with the subset of anomaly transactions and a distribution of the plurality of features associated with the subset of anomaly transactions, a plurality of weights associated with the plurality of features associated with the subset of anomaly transactions; segmenting, with the at least one processor, using an unsupervised clustering algorithm, based on the plurality of features associated with the subset of anomaly transactions and the plurality of weights associated with the plurality of features associated with the subset of anomaly transactions, the subset of anomaly transactions into a plurality of segments of anomaly transactions; and labeling, with the at least one processor, a subset of segments of the plurality of segments with a feature profile including a feature from each segment of the subset of segments associated with a highest weight of the plurality of weights of the plurality of features of the anomaly transactions in that segment.

Clause 2. The computer-implemented method of clause 2, wherein selecting the subset of anomaly transactions of the plurality of anomaly transactions includes determining a sample size n of the subset of anomaly transactions based on a distance d of true values of a multinomial population of the plurality of anomaly transactions at a significance level a.

Clause 3. The computer-implemented method of clauses 1 or 2, wherein the plurality of weights associated with the plurality of features associated with the subset of anomaly transactions is generated according to the following Equations:

$${q}_{N} ( x ) = {\sum }_{i = 1}^{N} p ( {x}_{i} ) N \leq K$$

$$s ( x ) = \frac{{\sum }_{N = 1}^{K} {q}_{N} ( x ) {e}^{- ( N - 1 )}}{{\sum }_{N = 1}^{K} {e}^{- ( N - 1 )}}$$

where xᵢ is a feature of the plurality of features, where xᵢ: p(xᵢ) i=1, 2, . . . , K, where i is a feature category, where K is a number of feature categories, where p(xᵢ) is a distribution of the features, where p(x₁)>p(x₂)> . . . >p(x_{K}), where q_{N}(x) is a cumulative sum of the probability distribution, where N is a selected number of feature categories, and where s(x) is a weight of the plurality of weights associated with the feature xᵢ.

Clause 4. The computer-implemented method of any of clauses 1-3, wherein the unsupervised clustering algorithm includes a modular-transform based clustering algorithm.

Clause 5. The computer-implemented method of any of clauses 1-4, further comprising: generating, with the at least one processor, using the anomaly detection system, during processing of the plurality of transactions in a transaction processing network, the plurality of anomaly transactions identified as anomalies within the plurality of transactions.

Clause 6. The computer-implemented method of any of clauses 1-5, wherein the anomaly detection system includes a fraud detection model, and wherein the plurality of anomaly transactions is identified as fraudulent transactions.

Clause 7. The computer-implemented method of any of clauses 1-6, further comprising: receiving, with the at least one processor, a current transaction currently being processed in the transaction processing network; generating, with the at least one processor, using the anomaly detection system, a current anomaly transaction identified as a current anomaly; automatically labeling, with the at least one processor, the current anomaly transaction by comparing one or more features associated with the current anomaly transaction to the feature profile, wherein the current anomaly transaction is labeled with the feature profile in response to a threshold number of the one or more features associated with the current anomaly transaction matching a threshold number of features in the feature profile; and updating, with the at least one processor, based on the current anomaly transaction, the feature profile.

Clause 8. A system comprising: at least one processor configured to: receive a plurality of anomaly transactions identified as anomalies by an anomaly detection system within a plurality of transactions; select a subset of anomaly transactions of the plurality of anomaly transactions, wherein the subset of anomaly transactions is associated with a plurality of features; generate, based on the plurality of features associated with the subset of anomaly transactions and a distribution of the plurality of features associated with the subset of anomaly transactions, a plurality of weights associated with the plurality of features associated with the subset of anomaly transactions; segment, using an unsupervised clustering algorithm, based on the plurality of features associated with the subset of anomaly transactions and the plurality of weights associated with the plurality of features associated with the subset of anomaly transactions, the subset of anomaly transactions into a plurality of segments of anomaly transactions; and label a subset of segments of the plurality of segments with a feature profile including a feature from each segment of the subset of segments associated with a highest weight of the plurality of weights of the plurality of features of the anomaly transactions in that segment.

Clause 9. The system of clause 8, wherein the at least one processor is configured to select the subset of anomaly transactions of the plurality of anomaly transactions by determining a sample size n of the subset of anomaly transactions based on a distance d of true values of a multinomial population of the plurality of anomaly transactions at a significance level a.

Clause 10. The system of clauses 8 or 9, wherein the at least one processor is configured to generate the plurality of weights associated with the plurality of features associated with the subset of anomaly transactions according to the following Equations:

$${q}_{N} ( x ) = {\sum }_{i = 1}^{N} p ( {x}_{i} ) N \leq K$$

$$s ( x ) = \frac{{\sum }_{N = 1}^{K} {q}_{N} ( x ) {e}^{- ( N - 1 )}}{{\sum }_{N = 1}^{K} {e}^{- ( N - 1 )}}$$

where xᵢ is a feature of the plurality of features, where xᵢ: p(xᵢ) i=1, 2, . . . , K, where i is a feature category, where K is a number of feature categories, where p(xᵢ) is a distribution of the features, where p(x₁)>p(x₂)> . . . >p(x_{K}), where q_{N}(x) is a cumulative sum of the probability distribution, where N is a selected number of feature categories, and where s(x) is a weight of the plurality of weights associated with the feature xᵢ.

Clause 11. The system of any of clauses 8-10, wherein the unsupervised clustering algorithm includes a modular-transform based clustering algorithm.

Clause 12. The system of any of clauses 8-11, wherein the at least one processor is further configured to: generate, using the anomaly detection system, during processing of the plurality of transactions in a transaction processing network, the plurality of anomaly transactions identified as anomalies within the plurality of transactions.

Clause 13. The system of any of clauses 8-12, wherein the anomaly detection system includes a fraud detection model, and wherein the plurality of anomaly transactions is identified as fraudulent transactions.

Clause 14. The system of any of clauses 8-13, wherein the at least one processor is further configured to: receive a current transaction currently being processed in the transaction processing network; generate, using the anomaly detection system, a current anomaly transaction identified as a current anomaly; automatically label the current anomaly transaction by comparing one or more features associated with the current anomaly transaction to the feature profile, wherein the current anomaly transaction is labeled with the feature profile in response to a threshold number of the one or more features associated with the current anomaly transaction matching a threshold number of features in the feature profile; and update based on the current anomaly transaction, the feature profile.

Clause 15. A computer program product including a non-transitory computer readable medium including program instructions which, when executed by at least one processor, cause the at least one processor to: receive a plurality of anomaly transactions identified as anomalies by an anomaly detection system within a plurality of transactions; select a subset of anomaly transactions of the plurality of anomaly transactions, wherein the subset of anomaly transactions is associated with a plurality of features; generate, based on the plurality of features associated with the subset of anomaly transactions and a distribution of the plurality of features associated with the subset of anomaly transactions, a plurality of weights associated with the plurality of features associated with the subset of anomaly transactions; segment, using an unsupervised clustering algorithm, based on the plurality of features associated with the subset of anomaly transactions and the plurality of weights associated with the plurality of features associated with the subset of anomaly transactions, the subset of anomaly transactions into a plurality of segments of anomaly transactions; and label a subset of segments of the plurality of segments with a feature profile including a feature from each segment of the subset of segments associated with a highest weight of the plurality of weights of the plurality of features of the anomaly transactions in that segment.

Clause 16. The computer program product of clause 15, wherein the program instructions, when executed by the at least one processor, further cause the at least one processor to select the subset of anomaly transactions of the plurality of anomaly transactions by determining a sample size n of the subset of anomaly transactions based on a distance d of true values of a multinomial population of the plurality of anomaly transactions at a significance level a.

Clause 17. The computer program product of clauses 15 or 16, wherein the program instructions, when executed by the at least one processor, further cause the at least one processor to generate the plurality of weights associated with the plurality of features associated with the subset of anomaly transactions according to the following Equations:

$${q}_{N} ( x ) = {\sum }_{i = 1}^{N} p ( {x}_{i} ) N \leq K$$

$$s ( x ) = \frac{{\sum }_{N = 1}^{K} {q}_{N} ( x ) {e}^{- ( N - 1 )}}{{\sum }_{N = 1}^{K} {e}^{- ( N - 1 )}}$$

where xᵢ is a feature of the plurality of features, where xᵢ: p(xᵢ) i=1, 2, . . . , K, where i is a feature category, where K is a number of feature categories, where p(xᵢ) is a distribution of the features, where p(x₁)>p(x₂)> . . . >p(x_{K}), where q_{N}(x) is a cumulative sum of the probability distribution, where N is a selected number of feature categories, and where s(x) is a weight of the plurality of weights associated with the feature xᵢ.

Clause 18. The computer program product of any of clauses 15-17, wherein the unsupervised clustering algorithm includes a modular-transform based clustering algorithm.

Clause 19. The computer program product of any of clauses 15-18, wherein the program instructions, when executed by the at least one processor, further cause the at least one processor to: generate, using the anomaly detection system, during processing of the plurality of transactions in a transaction processing network, the plurality of anomaly transactions identified as anomalies within the plurality of transactions.

Clause 20. The computer program product of any of clauses 15-19, wherein the program instructions, when executed by the at least one processor, further cause the at least one processor to: receive a current transaction currently being processed in the transaction processing network; generate, using the anomaly detection system, a current anomaly transaction identified as a current anomaly; automatically label the current anomaly transaction by comparing one or more features associated with the current anomaly transaction to the feature profile, wherein the current anomaly transaction is labeled with the feature profile in response to a threshold number of the one or more features associated with the current anomaly transaction matching a threshold number of features in the feature profile; and update based on the current anomaly transaction, the feature profile.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of limits. As used in the specification and the claims, the singular form of “a,” “an,” and “the” include plural referents unless the context clearly dictates otherwise.

### BRIEF DESCRIPTION OF THE DRAWINGS

Additional advantages and details are explained in greater detail below with reference to the exemplary embodiments that are illustrated in the accompanying schematic figures, in which:

FIG. 1 is a diagram of non-limiting embodiments or aspects of an environment in which systems, devices, products, apparatus, and/or methods, described herein, may be implemented;

FIG. 2 is a diagram of non-limiting embodiments or aspects of components of one or more devices and/or one or more systems of FIG. 1;

FIGS. 3A and 3B are a flowchart of non-limiting embodiments or aspects of a process for auto-profiling anomalies;

FIG. 4 is a table for selecting sample size for simultaneously estimating parameters of a multinomial population;

FIG. 5 is a diagram of an implementation of non-limiting embodiments or aspects of a process for feature distribution scoring; and

FIG. 6 is a diagram of an implementation of non-limiting embodiments or aspects of a process for auto-profiling anomalies identified by a real-time payments (RTP) system.

### DETAILED DESCRIPTION

It is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects. Hence, specific dimensions and other physical characteristics related to the embodiments or aspects disclosed herein are not to be considered as limiting.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like, of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and communicates the processed information to the second unit. In some non-limiting embodiments or aspects, a message may refer to a network packet (e.g., a data packet and/or the like) that includes data. It will be appreciated that numerous other arrangements are possible.

It will be apparent that systems and/or methods, described herein, can be implemented in different forms of hardware, software, or a combination of hardware and software. The actual specialized control hardware or software code used to implement these systems and/or methods is not limiting of the implementations. Thus, the operation and behavior of the systems and/or methods are described herein without reference to specific software code, it being understood that software and hardware can be designed to implement the systems and/or methods based on the description herein.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

As used herein, the term “transaction service provider” may refer to an entity that receives transaction authorization requests from merchants or other entities and provides guarantees of payment, in some cases through an agreement between the transaction service provider and an issuer institution. For example, a transaction service provider may include a payment network such as Visa® or any other entity that processes transactions. The term “transaction processing system” may refer to one or more computing devices operated by or on behalf of a transaction service provider, such as a transaction processing server executing one or more software applications. A transaction processing system may include one or more processors and, in some non-limiting embodiments, may be operated by or on behalf of a transaction service provider.

As used herein, the term “account identifier” may include one or more primary account numbers (PANs), tokens, or other identifiers associated with a customer account. The term “token” may refer to an identifier that is used as a substitute or replacement identifier for an original account identifier, such as a PAN. Account identifiers may be alphanumeric or any combination of characters and/or symbols. Tokens may be associated with a PAN or other original account identifier in one or more data structures (e.g., one or more databases and/or the like) such that they may be used to conduct a transaction without directly using the original account identifier. In some examples, an original account identifier, such as a PAN, may be associated with a plurality of tokens for different individuals or purposes.

As used herein, the terms “issuer institution,” “portable financial device issuer,” “issuer,” or “issuer bank” may refer to one or more entities that provide one or more accounts to a user (e.g., a customer, a consumer, an entity, an organization, and/or the like) for conducting transactions (e.g., payment transactions), such as initiating credit card payment transactions and/or debit card payment transactions. For example, an issuer institution may provide an account identifier, such as a PAN, to a user that uniquely identifies one or more accounts associated with that user. The account identifier may be embodied on a portable financial device, such as a physical financial instrument (e.g., a payment card), and/or may be electronic and used for electronic payments. In some non-limiting embodiments or aspects, an issuer institution may be associated with a bank identification number (BIN) that uniquely identifies the issuer institution. As used herein, the term “issuer institution system” may refer to one or more computer systems operated by or on behalf of an issuer institution, such as a server computer executing one or more software applications. For example, an issuer institution system may include one or more authorization servers for authorizing a payment transaction.

As used herein, the term “merchant” may refer to an individual or entity that provides goods and/or services, or access to goods and/or services, to users (e.g. customers) based on a transaction (e.g. a payment transaction). As used herein, the terms “merchant” or “merchant system” may also refer to one or more computer systems, computing devices, and/or software application operated by or on behalf of a merchant, such as a server computer executing one or more software applications. A “point-of-sale (POS) system,” as used herein, may refer to one or more computers and/or peripheral devices used by a merchant to engage in payment transactions with users, including one or more card readers, near-field communication (NFC) receivers, radio frequency identification (RFID) receivers, and/or other contactless transceivers or receivers, contact-based receivers, payment terminals, computers, servers, input devices, and/or other like devices that can be used to initiate a payment transaction. A POS system may be part of a merchant system. A merchant system may also include a merchant plug-in for facilitating online, Internet-based transactions through a merchant webpage or software application. A merchant plug-in may include software that runs on a merchant server or is hosted by a third-party for facilitating such online transactions.

As used herein, the term “mobile device” may refer to one or more portable electronic devices configured to communicate with one or more networks. As an example, a mobile device may include a cellular phone (e.g., a smartphone or standard cellular phone), a portable computer (e.g., a tablet computer, a laptop computer, etc.), a wearable device (e.g., a watch, pair of glasses, lens, clothing, and/or the like), a personal digital assistant (PDA), and/or other like devices. The terms “client device” and “user device,” as used herein, refer to any electronic device that is configured to communicate with one or more servers or remote devices and/or systems. A client device or user device may include a mobile device, a network-enabled appliance (e.g., a network-enabled television, refrigerator, thermostat, and/or the like), a computer, a POS system, and/or any other device or system capable of communicating with a network.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a PDA, and/or other like devices. A computing device may also be a desktop computer or other form of non-mobile computer.

As used herein, the term “payment device” may refer to a portable financial device, an electronic payment device, a payment card (e.g., a credit or debit card), a gift card, a smartcard, smart media, a payroll card, a healthcare card, a wristband, a machine-readable medium containing account information, a keychain device or fob, an RFID transponder, a retailer discount or loyalty card, a cellular phone, an electronic wallet mobile application, a PDA, a pager, a security card, a computer, an access card, a wireless terminal, a transponder, and/or the like. In some non-limiting embodiments or aspects, the payment device may include volatile or nonvolatile memory to store information (e.g., an account identifier, a name of the account holder, and/or the like).

As used herein, the term “server” may refer to or include one or more computing devices that are operated by or facilitate communication and processing for multiple parties in a network environment, such as the Internet, although it will be appreciated that communication may be facilitated over one or more public or private network environments and that various other arrangements are possible. Further, multiple computing devices (e.g., servers, point-of-sale (POS) devices, mobile devices, etc.) directly or indirectly communicating in the network environment may constitute a “system.”

As used herein, the term “system” may refer to one or more computing devices or combinations of computing devices (e.g., processors, servers, client devices, software applications, components of such, and/or the like). Reference to “a device,” “a server,” “a processor,” and/or the like, as used herein, may refer to a previously-recited device, server, or processor that is recited as performing a previous step or function, a different device, server, or processor, and/or a combination of devices, servers, and/or processors. For example, as used in the specification and the claims, a first device, a first server, or a first processor that is recited as performing a first step or a first function may refer to the same or different device, server, or processor recited as performing a second step or a second function.

As used herein, the term “acquirer” may refer to an entity licensed by the transaction service provider and/or approved by the transaction service provider to originate transactions using a portable financial device of the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

As used herein, the term “payment gateway” may refer to an entity and/or a payment processing system operated by or on behalf of such an entity (e.g., a merchant service provider, a payment service provider, a payment facilitator, a payment facilitator that contracts with an acquirer, a payment aggregator, and/or the like), which provides payment services (e.g., transaction service provider payment services, payment processing services, and/or the like) to one or more merchants. The payment services may be associated with the use of portable financial devices managed by a transaction service provider. As used herein, the term “payment gateway system” may refer to one or more computer systems, computer devices, servers, groups of servers, and/or the like operated by or on behalf of a payment gateway.

As used herein, the terms “authenticating system” and “authentication system” may refer to one or more computing devices that authenticate a user and/or an account, such as but not limited to a transaction processing system, merchant system, issuer system, payment gateway, a third-party authenticating service, and/or the like.

As used herein, the terms “request,” “response,” “request message,” and “response message” may refer to one or more messages, data packets, signals, and/or data structures used to communicate data between two or more components or units.

As used herein, the term “application programming interface” (API) may refer to computer code that allows communication between different systems or (hardware and/or software) components of systems. For example, an API may include function calls, functions, subroutines, communication protocols, fields, and/or the like usable and/or accessible by other systems or other (hardware and/or software) components of systems.

As used herein, the term “user interface” or “graphical user interface” refers to a generated display, such as one or more graphical user interfaces (GUIs) with which a user may interact, either directly or indirectly (e.g., through a keyboard, mouse, touchscreen, etc.).

As used herein, the term “real-time” refers to performance of a task or tasks during another process or before another process is completed. For example, a real-time inference may be an inference that is obtained from a model before a payment transaction is authorized, completed, settled, and/or the like.

Existing automatic profiling algorithms may not be directly applied to transaction data due to an un-even strength or contribution of transaction features for different anomalies. For example, transaction channel may be a strong indicator or contributor for a cash-out anomaly, but a relatively weak indicator or contributor for an anomaly associated with a large local musical event. Further, existing auto-profiling systems cannot quickly auto-profile anomalies based on unlabeled, large-scaled streaming data.

Non-limiting embodiments or aspects of the present disclose provide methods, systems, and computer program products that receive a plurality of anomaly transactions identified as anomalies by an anomaly detection system within a plurality of transactions; select a subset of anomaly transactions of the plurality of anomaly transactions, wherein the subset of anomaly transactions is associated with a plurality of features; generate, based on the plurality of features associated with the subset of anomaly transactions and a distribution of the plurality of features associated with the subset of anomaly transactions, a plurality of weights associated with the plurality of features associated with the subset of anomaly transactions; segment, using an unsupervised clustering algorithm, based on the plurality of features associated with the subset of anomaly transactions and the plurality of weights associated with the plurality of features associated with the subset of anomaly transactions, the subset of anomaly transactions into a plurality of segments of anomaly transactions; and label a subset of segments of the plurality of segments with a feature profile including a feature from each segment of the subset of segments associated with a highest weight of the plurality of weights of the plurality of features of the anomaly transactions in that segment.

In this way, non-limiting embodiments or aspects of the present disclosure may provide a framework that automatically profiles an anomaly in real-time or near real-time using distribution-based feature scoring that enables an unsupervised clustering algorithm to better learn a pattern of the anomaly, and for which feature scoring in different clustered communities may highlight a similarity of each community to provide a community profile or report. Moreover, non-limiting embodiments or aspects of the present disclosure may be used as an extension of any current real-time anomaly detection monitoring system, such as for Fraud Profiling, Event Profiling, real-time payments (RTP), and/or the like.

As an example, non-limiting embodiments or aspects of the present disclosure may provide novel feature scoring based on distribution that enables a clustering algorithm to pay more attention to features that are stronger indicators or contributors for particular anomalies, where the unsupervised clustering algorithm enables use of transactions that are missing labels and/or optimizing a number of clusters. Further, non-limiting embodiments or aspects of the present disclosure may separate anomaly communities of transactions from normal communities of transactions and/or profile the anomaly communities based on feature distribution scoring. Moreover, non-limiting embodiments or aspects of the present disclosure may sample transactions without ruining the distribution to make the near real-time possible for large-scale dataset (e.g., a subset of anomaly transactions of a plurality of anomaly transactions may be selected, etc.) using a sampling method as disclosed by Steven K. Thompson in the paper entitled “Sample Size for Estimating Multinomial Proportions”, 1987, the entire contents of which are incorporated herein by reference.

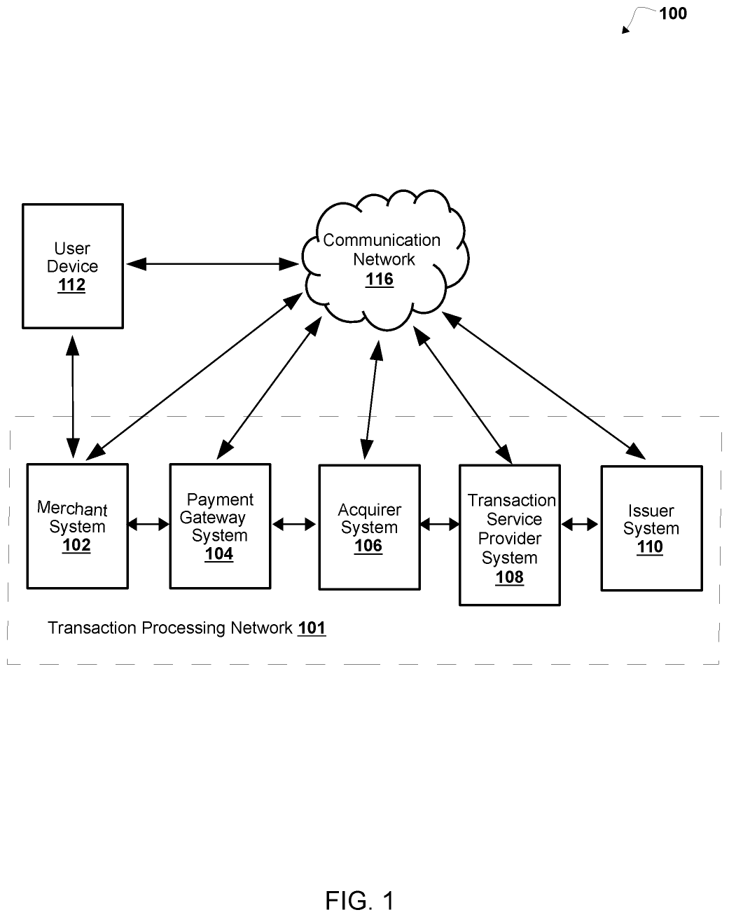

Referring now to FIG. 1, FIG. 1 is a diagram of an example environment 100 in which devices, systems, methods, and/or products described herein, may be implemented. As shown in FIG. 1, environment 100 includes transaction processing network 101, which may include merchant system 102, payment gateway system 104, acquirer system 106, transaction service provider system 108, issuer system 110, user device 112, and/or communication network 116. Transaction processing network 101, merchant system 102, payment gateway system 104, acquirer system 106, transaction service provider system 108, issuer system 110, and/or user device 112, may interconnect (e.g., establish a connection to communicate, etc.) via wired connections, wireless connections, or a combination of wired and wireless connections.

Merchant system 102 may include one or more devices capable of receiving information and/or data from payment gateway system 104, acquirer system 106, transaction service provider system 108, issuer system 110, and/or user device 112 (e.g., via communication network 116, etc.) and/or communicating information and/or data to payment gateway system 104, acquirer system 106, transaction service provider system 108, issuer system 110, and/or user device 112 (e.g., via communication network 116, etc.). Merchant system 102 may include a device capable of receiving information and/or data from user device 112 via a communication connection (e.g., an NFC communication connection, an RFID communication connection, a Bluetooth® communication connection, etc.) with user device 112 and/or communicating information and/or data to user device 112 via the communication connection. For example, merchant system 102 may include a computing device, such as a server, a group of servers, a client device, a group of client devices, and/or other like devices. In some non-limiting embodiments or aspects, merchant system 102 may be associated with a merchant as described herein. In some non-limiting embodiments or aspects, merchant system 102 may include one or more devices, such as computers, computer systems, and/or peripheral devices capable of being used by a merchant to conduct a payment transaction with a user. For example, merchant system 102 may include a POS device and/or a POS system.

Payment gateway system 104 may include one or more devices capable of receiving information and/or data from merchant system 102, acquirer system 106, transaction service provider system 108, issuer system 110, and/or user device 112 (e.g., via communication network 116, etc.) and/or communicating information and/or data to merchant system 102, acquirer system 106, transaction service provider system 108, issuer system 110, and/or user device 112 (e.g., via communication network 116, etc.). For example, payment gateway system 104 may include a computing device, such as a server, a group of servers, and/or other like devices. In some non-limiting embodiments or aspects, payment gateway system 104 is associated with a payment gateway as described herein.

Acquirer system 106 may include one or more devices capable of receiving information and/or data from merchant system 102, payment gateway system 104, transaction service provider system 108, issuer system 110, and/or user device 112 (e.g., via communication network 116, etc.) and/or communicating information and/or data to merchant system 102, payment gateway system 104, transaction service provider system 108, issuer system 110, and/or user device 112 (e.g., via communication network 116, etc.). For example, acquirer system 106 may include a computing device, such as a server, a group of servers, and/or other like devices. In some non-limiting embodiments or aspects, acquirer system 106 may be associated with an acquirer as described herein.

Transaction service provider system 108 may include one or more devices capable of receiving information and/or data from merchant system 102, payment gateway system 104, acquirer system 106, issuer system 110, and/or user device 112 (e.g., via communication network 116, etc.) and/or communicating information and/or data to merchant system 102, payment gateway system 104, acquirer system 106, issuer system 110, and/or user device 112 (e.g., via communication network 116, etc.). For example, transaction service provider system 108 may include a computing device, such as a server (e.g., a transaction processing server, etc.), a group of servers, and/or other like devices. In some non-limiting embodiments or aspects, transaction service provider system 108 may be associated with a transaction service provider as described herein. In some non-limiting embodiments or aspects, transaction service provider system 108 may include and/or access one or more internal and/or external databases including transaction data.

Issuer system 110 may include one or more devices capable of receiving information and/or data from merchant system 102, payment gateway system 104, acquirer system 106, transaction service provider system 108, and/or user device 112 (e.g., via communication network 116, etc.) and/or communicating information and/or data to merchant system 102, payment gateway system 104, acquirer system 106, transaction service provider system 108, and/or user device 112 (e.g., via communication network 116 etc.). For example, issuer system 110 may include a computing device, such as a server, a group of servers, and/or other like devices. In some non-limiting embodiments or aspects, issuer system 110 may be associated with an issuer institution as described herein. For example, issuer system 110 may be associated with an issuer institution that issued a payment account or instrument (e.g., a credit account, a debit account, a credit card, a debit card, etc.) to a user (e.g., a user associated with user device 112, etc.).

In some non-limiting embodiments or aspects, transaction processing network 101 includes a plurality of systems in a communication path for processing a transaction. For example, transaction processing network 101 can include merchant system 102, payment gateway system 104, acquirer system 106, transaction service provider system 108, and/or issuer system 110 in a communication path (e.g., a communication path, a communication channel, a communication network, etc.) for processing an electronic payment transaction. As an example, transaction processing network 101 can process (e.g., initiate, conduct, authorize, etc.) an electronic payment transaction via the communication path between merchant system 102, payment gateway system 104, acquirer system 106, transaction service provider system 108, and/or issuer system 110.

User device 112 may include one or more devices capable of receiving information and/or data from merchant system 102, payment gateway system 104, acquirer system 106, transaction service provider system 108, and/or issuer system 110 (e.g., via communication network 116, etc.) and/or communicating information and/or data to merchant system 102, payment gateway system 104, acquirer system 106, transaction service provider system 108, and/or issuer system 110 (e.g., via communication network 116, etc.). For example, user device 112 may include a client device and/or the like. In some non-limiting embodiments or aspects, user device 112 may be capable of receiving information (e.g., from merchant system 102, etc.) via a short range wireless communication connection (e.g., an NFC communication connection, an RFID communication connection, a Bluetooth® communication connection, and/or the like), and/or communicating information (e.g., to merchant system 102, etc.) via a short range wireless communication connection. In some non-limiting embodiments or aspects, user device 112 may include an application associated with user device 112, such as an application stored on user device 112, a mobile application (e.g., a mobile device application, a native application for a mobile device, a mobile cloud application for a mobile device, an electronic wallet application, an issuer bank application, and/or the like) stored and/or executed on user device 112. In some non-limiting embodiments or aspects, user device 112 may be associated with a sender account and/or a receiving account in a payment network for one or more transactions in the payment network.

Communication network 116 may include one or more wired and/or wireless networks. For example, communication network 116 may include a cellular network (e.g., a long-term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and systems shown in FIG. 1 is provided as an example. There may be additional devices and/or systems, fewer devices and/or systems, different devices and/or systems, or differently arranged devices and/or systems than those shown in FIG. 1. Furthermore, two or more devices and/or systems shown in FIG. 1 may be implemented within a single device and/or system, or a single device and/or system shown in FIG. 1 may be implemented as multiple, distributed devices and/or systems. Additionally or alternatively, a set of devices and/or systems (e.g., one or more devices or systems) of environment 100 may perform one or more functions described as being performed by another set of devices and/or systems of environment 100.

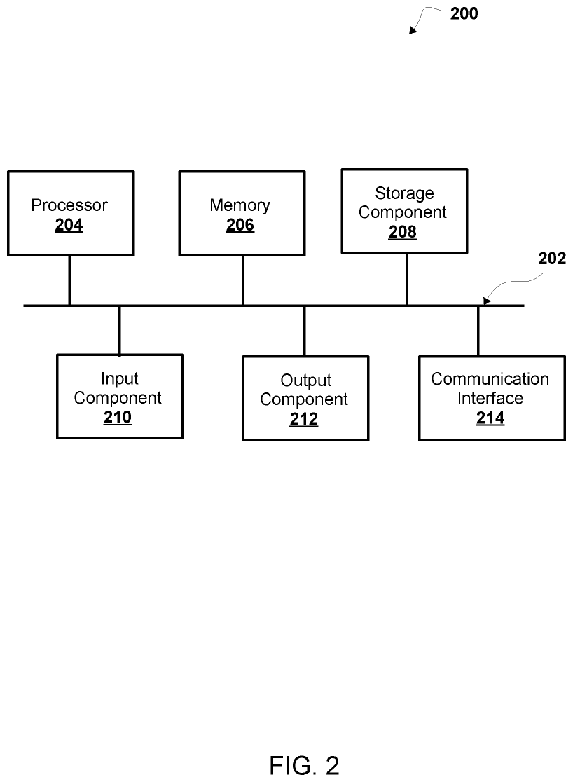

Referring now to FIG. 2, FIG. 2 is a diagram of example components of a device 200. Device 200 may correspond to one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.). In some non-limiting embodiments or aspects, one or more devices of merchant system 102, one or more devices of payment gateway system 104, one or more devices of acquirer system 106, one or more devices of transaction service provider system 108, one or more devices of issuer system 110, and/or user device 112 (e.g., one or more devices of a system of user device 112, etc.) may include at least one device 200 and/or at least one component of device 200. As shown in FIG. 2, device 200 may include bus 202, processor 204, memory 206, storage component 208, input component 210, output component 212, and communication interface 214.

Bus 202 may include a component that permits communication among the components of device 200. In some non-limiting embodiments or aspects, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read-only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 (e.g., a central processing unit (CPU), a graphics processing unit (GPU), etc.) executing software instructions stored by a computer-readable medium, such as memory 206 and/or storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

Memory 206 and/or storage component 208 may include data storage or one or more data structures (e.g., a database, etc.). Device 200 may be capable of receiving information from, storing information in, communicating information to, or searching information stored in the data storage or one or more data structures in memory 206 and/or storage component 208. The term “configured to,” as used herein, may refer to an arrangement of software, device(s), and/or hardware for performing and/or enabling one or more functions (e.g., actions, processes, steps of a process, and/or the like). For example, “a processor configured to” may refer to a processor that executes software instructions (e.g., program code) that cause the processor to perform one or more functions.

The number and arrangement of components shown in FIG. 2 are provided as an example. In some non-limiting embodiments or aspects, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

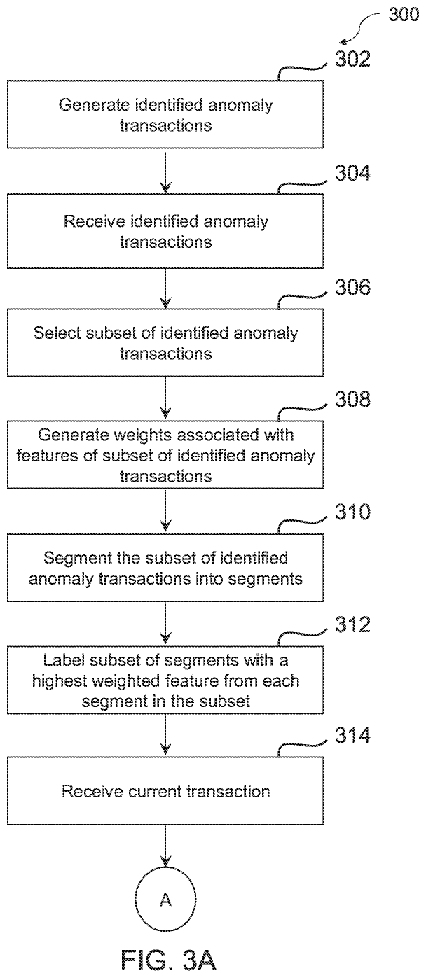

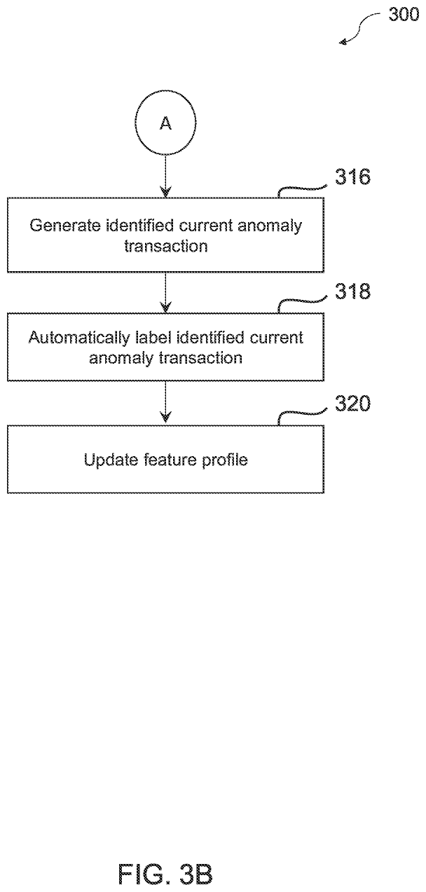

Referring now to FIGS. 3A and 3B, FIGS. 3A and 3B are a flowchart of non-limiting embodiments or aspects of a process 300 for auto-profiling anomalies. In some non-limiting embodiments or aspects, one or more of the steps of process 300 may be performed (e.g., completely, partially, etc.) by transaction service provider system 108 (e.g., one or more devices of transaction service provider system 108). In some non-limiting embodiments or aspects, one or more of the steps of process 300 may be performed (e.g., completely, partially, etc.) by another device or a group of devices separate from or including transaction service provider system 108, such as, (e.g., one or more devices of merchant system 102), payment gateway system 104 (e.g., one or more devices of payment gateway system 104), acquirer system 106 (e.g., one or more devices of acquirer system 106), issuer system 110 (e.g., one or more devices of issuer system 110), and/or user device 112.

As shown in FIG. 3A, at step 302, process 300 includes generating a plurality of anomaly transactions identified as anomalies within a plurality of transactions. For example, transaction service provider system 108 may generate, using an anomaly detection system, during processing of a plurality of transactions in a transaction processing network (e.g., transaction processing network 101, etc.), a plurality of anomaly transactions identified as anomalies within the plurality of transactions. As an example, transaction service provider system 108 may determine, using an anomaly detection system, during processing of a transaction in a transaction processing network (e.g., transaction processing network 101, etc.), based on transaction parameters and/or features associated with the transaction, whether the transaction is an anomaly transaction identified as an anomaly. In such an example, transaction service provider system 108 may generate or provide a transaction identified as an anomaly as an anomaly transaction, and/or the anomaly transaction may be associated with a plurality of features.

An anomaly detection system may include a fraud detection system or model, an event profiling system or model, a real-time payments (RTP) system or model, and/or the like. A fraud detection system or model may be configured to receive transactions parameters associated with transactions and identify fraudulent transactions in the transactions as anomalies based on the transaction parameters. An event profiling system or model may be configured to receive transaction parameters associated with transactions and identify transactions associated with predetermined events (e.g., an automated teller machine (ATM) cashout, a large music festival, a sporting event, etc.) in the transactions as anomalies based on the transaction parameters. A real-time payments system or model may be configured to receive transaction parameters associated with transactions (e.g., business and person-to-person (P2P) payment transactions, etc.) and identify transactions under monitoring and/or alerts in the transactions as anomalies based on the transaction parameters.

In some non-limiting embodiments or aspects, an anomaly detection system may be implemented (e.g., completely, partially, etc.) by transaction service provider system 108 (e.g., one or more devices of transaction service provider system 108). In some non-limiting embodiments or aspects, an anomaly detection system may be implemented (e.g., completely, partially, etc.) by another device or a group of devices separate from or including transaction service provider system 108, such as, (e.g., one or more devices of merchant system 102), payment gateway system 104 (e.g., one or more devices of payment gateway system 104), acquirer system 106 (e.g., one or more devices of acquirer system 106), issuer system 110 (e.g., one or more devices of issuer system 110), and/or user device 112.

A transaction may be associated with and/or correspond to a payment transaction (e.g., a payment transaction in an electronic payment network, etc.) and/or include transaction data associated with the transaction (e.g., transaction parameters associated with the transaction, etc.). For example, transaction data may include transaction parameters associated with a transaction, such as an account identifier (e.g., a PAN, etc.), a transaction amount, a transaction date and/or time, a type of products and/or services associated with the transaction, a conversion rate of currency, a type of currency, a merchant type, a merchant name, a merchant location, and/or the like. However, non-limiting embodiments or aspects are not limited thereto, and transaction parameters of a transaction may include any data including any type of parameters associated with any type of transaction.

A feature (e.g., categorical features, numerical features, local features, graph features or embeddings, etc.) associated with a transaction (e.g., an anomaly transaction, etc.) may include transaction parameters of the transaction, features determined based thereon (e.g., using feature engineering, etc.), and/or the like. However, non-limiting embodiments or aspects are not limited thereto, and features of a transaction may include any data including any type of features that may be generated from data associated with a transaction.

As shown in FIG. 3A, at step 304, process 300 includes receiving a plurality of anomaly transactions identified as anomalies by an anomaly detection system within a plurality of transactions. For example, transaction service provider system 108 may receive a plurality of anomaly transactions identified as anomalies by an anomaly detection system within a plurality of transactions. As an example, transaction service provider system 108 may receive, from the anomaly detection system, the plurality of anomaly transactions identified as anomalies by the anomaly detection system within the plurality of transactions (e.g., a plurality of anomaly transaction identified as fraudulent transactions, etc.).

As shown in FIG. 3A, at step 306, process 300 includes selecting a subset of anomaly transactions of a plurality of anomaly transactions. For example, transaction service provider system 108 may select (e.g., randomly sample, etc.) a subset of anomaly transactions of the plurality of anomaly transactions. In such an example, the subset of anomaly transactions may be associated with a plurality of features. As an example, each anomaly transaction in the subset of anomaly transactions may be associated with a plurality of features.

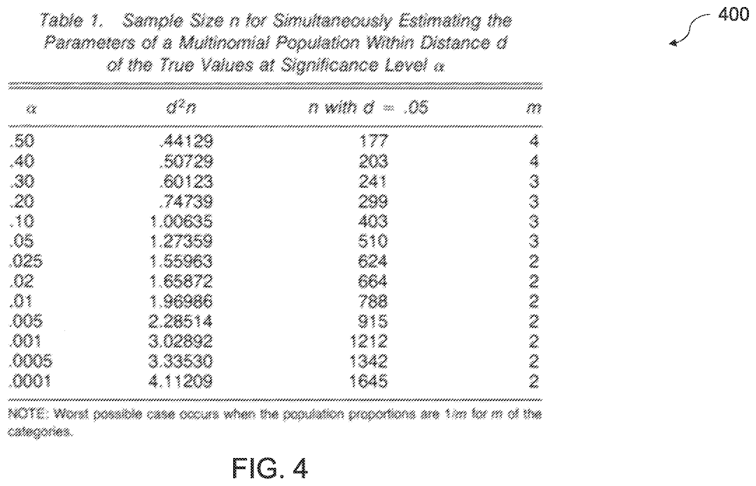

Referring also to FIG. 4, which is a table 400 for selecting sample size for simultaneously estimating parameters of a multinomial population, transaction service provider system 108 may select the subset of anomaly transactions of the plurality of anomaly transactions by determining a sample size n of the subset of anomaly transactions based on a distance d of true values of a multinomial population of the plurality of anomaly transactions at a significance level a. As an example, transaction service provider system 108 may sample the plurality of anomaly transactions (e.g., randomly select a subset of anomaly transactions of a plurality of anomaly transactions, etc.) without ruining the distribution, which may enable near real-time auto-profiling for large-scale datasets, by using a sampling method for determining a sample size as disclosed by Steven K. Thompson in the paper entitled “Sample Size for Estimating Multinomial Proportions”, 1987, the entire contents of which are incorporated herein by reference.

As shown in FIG. 3A, at step 308, process 300 includes generating weights associated with features of a subset of anomaly transactions. For example, transaction service provider system 108 may generate, based on the plurality of features associated with the subset of anomaly transactions and a distribution of the plurality of features associated with the subset of anomaly transactions, a plurality of weights associated with the plurality of features associated with the subset of anomaly transactions. As an example, transaction service provider system 108 may receive an anomaly transaction in the subset of anomaly transactions and, based on features of the anomaly transaction and the distribution thereof, generate a weight for each of the features of the anomaly transaction.

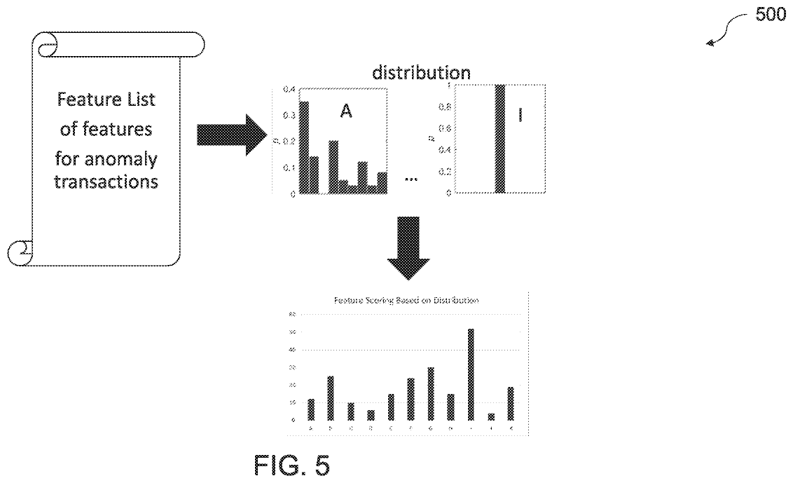

Referring also to FIG. 5, which is a diagram of an implementation 500 of non-limiting embodiments or aspects of a process for feature distribution scoring, transaction service provider system 108 may generate the plurality of weights associated with the plurality of features associated with the subset of anomaly transactions according to the following Equations (1) and (2):

$${q}_{N} ( x ) = {\sum }_{i = 1}^{N} p ( {x}_{i} ) N \leq K$$

$$s ( x ) = \frac{{\sum }_{N = 1}^{K} {q}_{N} ( x ) {e}^{- ( N - 1 )}}{{\sum }_{N = 1}^{K} {e}^{- ( N - 1 )}}$$

where xᵢ is a feature of the plurality of features, where xᵢ: p(xᵢ) i=1, 2, . . . , K, where i is a feature category, where K is a number of feature categories, where p(xᵢ) is a distribution of the features, where p(x₁)>p(x₂)> . . . >p(x_{K}), where q_{N}(x) is a cumulative sum of the probability distribution, where N is a selected number of feature categories, and where s(x) is a weight of the plurality of weights associated with the feature xᵢ. For example, a process for feature distribution scoring according to non-limiting embodiments or aspects may increase performance of an auto-profiling process, which may include community profiling based on feature distribution scoring to auto-profile clustered communities, by weighting features based on distribution, thereby putting less weights on unnecessary features for community profiling to enable clustering or segmenting to pay more attention on more relevant features. In contrast, existing auto-profiling systems cannot be directly applied to transaction data due to un-even relevance of transaction features. For example, a channel may be very relevant for identifying transaction associated with a cashout anomaly but much less relevant for identifying transactions associated with a large local musical event (also an anomaly).

As shown in FIG. 3A, at step 310, process 300 includes segmenting a subset of anomaly transactions into a plurality of segments of anomaly transactions. For example, transaction service provider system 108 may segment, using an unsupervised clustering algorithm, based on the plurality of features associated with the subset of anomaly transactions and the plurality of weights associated with the plurality of features associated with the subset of anomaly transactions, the subset of anomaly transactions into a plurality of segments of anomaly transactions. In such an example, an unsupervised clustering algorithm may be used for segmenting or clustering the subset of anomaly transactions into the plurality of segments of anomaly transactions because the subset of anomaly transactions (and the plurality of anomaly transactions from which the subset is selected) may be unlabeled (e.g., not associated with a label, etc.).

An unsupervised clustering algorithm used for segmenting the subset of anomaly transactions into the plurality of segments of anomaly transactions may include modular-transform based clustering, K-means clustering, density-based spatial clustering of applications with noise (DBSCAN), and/or the like. In such an example, a number of segments or clustered communities may be optimized by the unsupervised clustering algorithm.

As shown in FIG. 3A, at step 312, process 300 includes labeling a subset of segments of a plurality of segments of anomaly transactions with a highest weighted feature from each segment in the subset of segments. For example, transaction service provider system 108 may label a subset of segments (e.g., a community, etc.) of the plurality of segments with a feature profile including a feature from each segment of the subset of segments associated with a highest weight of the plurality of weights of the plurality of features of the anomaly transactions in that segment. As an example, transaction service provider system 108 may receive the plurality of segments of anomaly transactions and, for each segment, assign a feature with the highest weight from that segment to a label or feature profile for the subset or community including that segment. In such an example, if a highest weighted feature is not found or present for a segment or community, the transactions in that segment may be determined to be non-anomalous or normal transactions (e.g., not part of the anomaly community, etc.). In this way, transaction service provider system 108 may generate at least one anomaly subset of segments or anomaly community labeled with the highest weighted features of the segments included therein and at least one non-anomalous or normal community including one or more segments for which a highest weighted feature is not found or present. In such an example, a plurality of subsets of anomaly segments or anomaly communities may be generated to differentiate between different types of actual anomalies (e.g., different types of fraud, etc.).

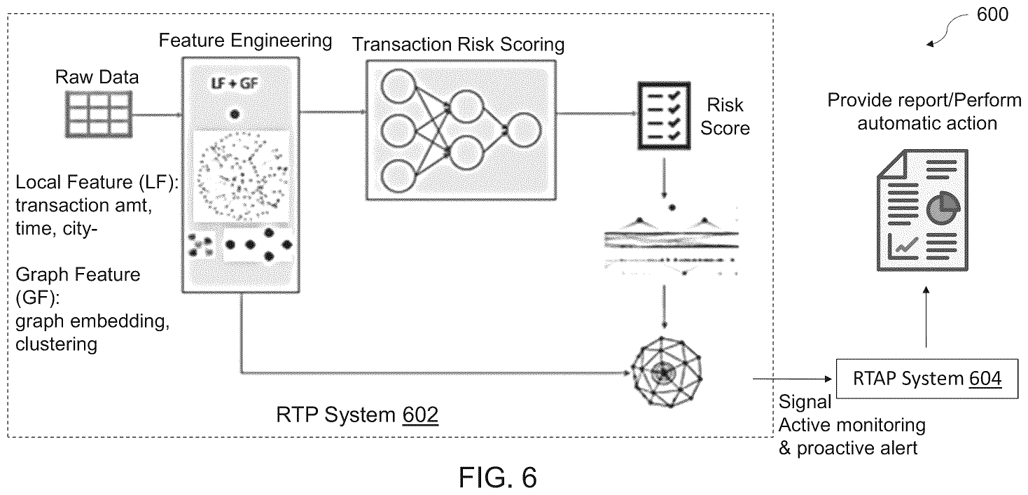

As shown in FIG. 3A, at step 314, process 300 includes receiving a current transaction. For example, transaction service provider system 108 may receive a current transaction currently being processed in the transaction processing network (e.g., transaction processing network 101, etc.). As an example, transaction service provider system 108 may receive transaction parameters and/or features associated with the current transaction. For example, and referring also to FIG. 6, which is a diagram of an implementation 600 of non-limiting embodiments or aspects of a process for auto-profiling anomalies identified by a real-time payments (RTP) system, RTP system 602 may receive raw transaction data associated with a transaction currently being processed in the transaction processing network.

As shown in FIG. 3B, at step 316, process 300 includes generating a current anomaly transaction identified as a current anomaly. For example, transaction service provider system 108 may generate, using the anomaly detection system, a current anomaly transaction identified as a current anomaly. As an example, transaction service provider system 108 may use the anomaly detection system to identify the current transaction as an anomaly transaction and generate the current anomaly transaction identified as the current anomaly. For example, and referring again to FIG. 6, RTP system 602 may perform feature engineering, transaction risk scoring, and/or the like on the transaction data associated with the current transaction to identify the current transaction as an anomaly, and provide the current transaction as a current anomaly transaction and/or a transaction to be actively monitored.

As shown in FIG. 3B, at step 318, process 300 includes automatically labeling a current anomaly transaction. For example, transaction service provider system 108 may automatically label the current anomaly transaction by comparing one or more features associated with the current anomaly transaction to the feature profile. As an example, transaction service provider system 108 may automatically label the current anomaly transaction with the feature profile in response to a threshold number of the one or more features associated with the current anomaly transaction matching a threshold number of features in the feature profile. For example, and referring again to FIG. 6, real-time auto-profiling (RTAP) system 604 may receive, from RTP system 602, the parameters and/or features associated with the current anomaly transaction, compare the parameters and/or features associated with the currently anomaly transaction to one or more labels or feature profiles of one or more anomaly subsets or communities that were labeled with their highest weighted features, and automatically label the current anomaly transaction with the feature profile of the one or more subsets or communities associated with a feature profile that matches a threshold number of the one or more features associated with the current anomaly transaction.

In some non-limiting embodiments or aspects, transaction service provider system 108 may provide a report associated with the feature profile or community assigned to the current anomaly transaction. In some non-limiting embodiments or aspects, transaction service provider system 108 (and/or issuer system 110, etc.) may automatically decline the current anomaly transaction in the transaction processing network (e.g., in transaction processing network 101, etc.) in response to the current anomaly transaction being assigned to an anomaly community. For example, and referring again to FIG. 6, RTAP system 604 may automatically notify transaction service provider system 108 and/or issuer system 110 that the current anomaly transaction is an actual anomaly and, in response to receiving the notification, transaction service provider system 108 and/or issuer system 110 may automatically decline and/or suspend processing of the current anomaly transaction in the RTP network. As an example, RTAP system 604 may automatically notify transaction service provider system 108 and/or issuer system 110 that the current anomaly transaction is not an actual anomaly (e.g., not real fraud, etc.) and, in response to receiving the notification, transaction service provider system 108 and/or issuer system 110 may automatically authorize and/or continue processing of the current anomaly transaction in the RTP network.

As shown in FIG. 3B, at step 320, process 300 includes updating a feature profile. For example, transaction service provider system 108 may update, based on the current anomaly transaction, the feature profile. As an example, transaction service provider system 108 may update, based on the current anomaly transaction, the feature profile for the subset or community including the segment to which the current anomaly transaction is assigned. In such an example, transaction service provider system 108 may automatically relabel the subset of segments or community with an updated feature profile including a feature from a segment in which the current anomaly transaction is now included. For example, transaction service provider system 108 may automatically relabel the subset of segments or community before processing a next current anomaly transaction.

Although embodiments or aspects have been described in detail for the purpose of illustration and description, it is to be understood that such detail is solely for that purpose and that embodiments or aspects are not limited to the disclosed embodiments or aspects, but, on the contrary, are intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect. In fact, any of these features can be combined in ways not specifically recited in the claims and/or disclosed in the specification. Although each dependent claim listed below may directly depend on only one claim, the disclosure of possible implementations includes each dependent claim in combination with every other claim in the claim set.

1. A computer-implemented method, comprising:
receiving, with at least one processor, a plurality of anomaly transactions identified as anomalies by an anomaly detection system within a plurality of transactions;
selecting, with the at least one processor, a subset of anomaly transactions of the plurality of anomaly transactions, wherein the subset of anomaly transactions is associated with a plurality of features;
generating, with the at least one processor, based on the plurality of features associated with the subset of anomaly transactions and a distribution of the plurality of features associated with the subset of anomaly transactions, a plurality of weights associated with the plurality of features associated with the subset of anomaly transactions;
segmenting, with the at least one processor, using an unsupervised clustering algorithm, based on the plurality of features associated with the subset of anomaly transactions and the plurality of weights associated with the plurality of features associated with the subset of anomaly transactions, the subset of anomaly transactions into a plurality of segments of anomaly transactions; and
labeling, with the at least one processor, a subset of segments of the plurality of segments with a feature profile including a feature from each segment of the subset of segments associated with a highest weight of the plurality of weights of the plurality of features of the anomaly transactions in that segment.

2. The computer-implemented method of claim 1, wherein selecting the subset of anomaly transactions of the plurality of anomaly transactions includes determining a sample size n of the subset of anomaly transactions based on a distance d of true values of a multinomial population of the plurality of anomaly transactions at a significance level a.

3. The computer-implemented method of claim 1, wherein the plurality of weights associated with the plurality of features associated with the subset of anomaly transactions is generated according to the following Equations:
$${q}_{N} ( x ) = {\sum }_{i = 1}^{N} p ( {x}_{i} ) N \leq K$$
$$s ( x ) = \frac{{\sum }_{N = 1}^{K} {q}_{N} ( x ) {e}^{- ( N - 1 )}}{{\sum }_{N = 1}^{K} {e}^{- ( N - 1 )}}$$
where xᵢ is a feature of the plurality of features, where xᵢ: p(xᵢ) i=1, 2, . . . , K, where i is a feature category, where K is a number of feature categories, where p(xᵢ) is a distribution of the features, where p(x₁)>p(x₂)> . . . >p(x_{K}), where q_{N}(x) is a cumulative sum of the probability distribution, where N is a selected number of feature categories, and where s(x) is a weight of the plurality of weights associated with the feature xᵢ.

4. The computer-implemented method of claim 1, wherein the unsupervised clustering algorithm includes a modular-transform based clustering algorithm.

5. The computer-implemented method of claim 1, further comprising:
generating, with the at least one processor, using the anomaly detection system, during processing of the plurality of transactions in a transaction processing network, the plurality of anomaly transactions identified as anomalies within the plurality of transactions.

6. The computer-implemented method of claim 5, wherein the anomaly detection system includes a fraud detection model, and wherein the plurality of anomaly transactions is identified as fraudulent transactions.

7. The computer-implemented method of claim 5, further comprising:
receiving, with the at least one processor, a current transaction currently being processed in the transaction processing network;
generating, with the at least one processor, using the anomaly detection system, a current anomaly transaction identified as a current anomaly;
automatically labeling, with the at least one processor, the current anomaly transaction by comparing one or more features associated with the current anomaly transaction to the feature profile, wherein the current anomaly transaction is labeled with the feature profile in response to a threshold number of the one or more features associated with the current anomaly transaction matching a threshold number of features in the feature profile; and
updating, with the at least one processor, based on the current anomaly transaction, the feature profile.

8. A system comprising:
at least one processor configured to:
receive a plurality of anomaly transactions identified as anomalies by an anomaly detection system within a plurality of transactions;
select a subset of anomaly transactions of the plurality of anomaly transactions, wherein the subset of anomaly transactions is associated with a plurality of features;
generate, based on the plurality of features associated with the subset of anomaly transactions and a distribution of the plurality of features associated with the subset of anomaly transactions, a plurality of weights associated with the plurality of features associated with the subset of anomaly transactions;
segment, using an unsupervised clustering algorithm, based on the plurality of features associated with the subset of anomaly transactions and the plurality of weights associated with the plurality of features associated with the subset of anomaly transactions, the subset of anomaly transactions into a plurality of segments of anomaly transactions; and
label a subset of segments of the plurality of segments with a feature profile including a feature from each segment of the subset of segments associated with a highest weight of the plurality of weights of the plurality of features of the anomaly transactions in that segment.

9. The system of claim 8, wherein the at least one processor is configured to select the subset of anomaly transactions of the plurality of anomaly transactions by determining a sample size n of the subset of anomaly transactions based on a distance d of true values of a multinomial population of the plurality of anomaly transactions at a significance level a.

10. The system of claim 8, wherein the at least one processor is programmed and/or configured to generate the plurality of weights associated with the plurality of features associated with the subset of anomaly transactions according to the following Equations:
$${q}_{N} ( x ) = {\sum }_{i = 1}^{N} p ( {x}_{i} ) N \leq K$$
$$s ( x ) = \frac{{\sum }_{N = 1}^{K} {q}_{N} ( x ) {e}^{- ( N - 1 )}}{{\sum }_{N = 1}^{K} {e}^{- ( N - 1 )}}$$
where xᵢ is a feature of the plurality of features, where xᵢ: p(xᵢ) i=1, 2, . . . , K, where i is a feature category, where K is a number of feature categories, where p(xᵢ) is a distribution of the features, where p(x₁)>p(x₂)> . . . >p(x_{K}), where q_{N}(x) is a cumulative sum of the probability distribution, where N is a selected number of feature categories, and where s(x) is a weight of the plurality of weights associated with the feature xᵢ.

11. The system of claim 8, wherein the unsupervised clustering algorithm includes a modular-transform based clustering algorithm.

12. The system of claim 8, wherein the at least one processor is further configured to:
generate, using the anomaly detection system, during processing of the plurality of transactions in a transaction processing network, the plurality of anomaly transactions identified as anomalies within the plurality of transactions.

13. The system of claim 12, wherein the anomaly detection system includes a fraud detection model, and wherein the plurality of anomaly transactions is identified as fraudulent transactions.

14. The system of claim 12, wherein the at least one processor is further configured to:
receive a current transaction currently being processed in the transaction processing network;
generate, using the anomaly detection system, a current anomaly transaction identified as a current anomaly;
automatically label the current anomaly transaction by comparing one or more features associated with the current anomaly transaction to the feature profile, wherein the current anomaly transaction is labeled with the feature profile in response to a threshold number of the one or more features associated with the current anomaly transaction matching a threshold number of features in the feature profile; and
update, based on the current anomaly transaction, the feature profile.

15. A computer program product including a non-transitory computer readable medium including program instructions which, when executed by at least one processor, cause the at least one processor to:
receive a plurality of anomaly transactions identified as anomalies by an anomaly detection system within a plurality of transactions;
select a subset of anomaly transactions of the plurality of anomaly transactions, wherein the subset of anomaly transactions is associated with a plurality of features;
generate, based on the plurality of features associated with the subset of anomaly transactions and a distribution of the plurality of features associated with the subset of anomaly transactions, a plurality of weights associated with the plurality of features associated with the subset of anomaly transactions;
segment, using an unsupervised clustering algorithm, based on the plurality of features associated with the subset of anomaly transactions and the plurality of weights associated with the plurality of features associated with the subset of anomaly transactions, the subset of anomaly transactions into a plurality of segments of anomaly transactions; and
label a subset of segments of the plurality of segments with a feature profile including a feature from each segment of the subset of segments associated with a highest weight of the plurality of weights of the plurality of features of the anomaly transactions in that segment.

16. The computer program product of claim 15, wherein the program instructions, when executed by the at least one processor, further cause the at least one processor to select the subset of anomaly transactions of the plurality of anomaly transactions by determining a sample size n of the subset of anomaly transactions based on a distance d of true values of a multinomial population of the plurality of anomaly transactions at a significance level a.

17. The computer program product of claim 15, wherein the program instructions, when executed by the at least one processor, further cause the at least one processor to generate the plurality of weights associated with the plurality of features associated with the subset of anomaly transactions according to the following Equations:
$${q}_{N} ( x ) = {\sum }_{i = 1}^{N} p ( {x}_{i} ) N \leq K$$
$$s ( x ) = \frac{{\sum }_{N = 1}^{K} {q}_{N} ( x ) {e}^{- ( N - 1 )}}{{\sum }_{N = 1}^{K} {e}^{- ( N - 1 )}}$$
where xᵢ is a feature of the plurality of features, where xᵢ: p(xᵢ) i=1, 2, . . . , K, where i is a feature category, where K is a number of feature categories, where p(xᵢ) is a distribution of the features, where p(x₁)>p(x₂)> . . . >p(x_{K}), where q_{N}(x) is a cumulative sum of the probability distribution, where N is a selected number of feature categories, and where s(x) is a weight of the plurality of weights associated with the feature xᵢ.

18. The computer program product of claim 15, wherein the unsupervised clustering algorithm includes a modular-transform based clustering algorithm.

19. The computer program product of claim 15, wherein the program instructions, when executed by the at least one processor, further cause the at least one processor to:
generate, using the anomaly detection system, during processing of the plurality of transactions in a transaction processing network, the plurality of anomaly transactions identified as anomalies within the plurality of transactions.

20. The computer program product of claim 19, wherein the program instructions, when executed by the at least one processor, further cause the at least one processor to:
receive a current transaction currently being processed in the transaction processing network;
generate, using the anomaly detection system, a current anomaly transaction identified as a current anomaly;
automatically label the current anomaly transaction by comparing one or more features associated with the current anomaly transaction to the feature profile, wherein the current anomaly transaction is labeled with the feature profile in response to a threshold number of the one or more features associated with the current anomaly transaction matching a threshold number of features in the feature profile; and
update, based on the current anomaly transaction, the feature profile.
